(19) United States
(12) Patent Application Publication
(10) Pub. No.: US 2002/0143502 A1
(43) Pub. Date: Oct. 3, 2002

(54) Apparatus and methods for attacking a screening algorithm using digital signal processing

(75) Inventor: Antonius A.M. Staring, Eindhoven (NL)

Correspondence Address: U.S. Philips Corporation, Corporate Patent Counsel, 580 White Plains Road, Tarrytown, NY, 10591, US

(73) Assignee: KONINKLIJKE PHILIPS ELECTRONICS N.V.

(21) Appl. No.: 10/043,390

(22) Filed: Oct. 26, 2001

Related U.S. Application Data
(60) Provisional application No. 60/279,639, filed on Mar. 29, 2001.

(51) Int. Cl. G06F 15/00

(52) U.S. Cl. 702/189

(57) ABSTRACT

Apparatus and methods for attacking a screening algorithm. Content is transformed within a first transformation device, then subjected to a screening algorithm, and finally transformed within a second transformation device. A watermark within the content is manipulated within the first transformation device by, for example, adding a pseudo-random sequence. The second transformation device removes the pseudo-random sequence or otherwise reverses the manipulation performed on the content after the content has been admitted into the secure domain.

### CROSS REFERENCE TO RELATED APPLICATION

This application claims priority to the U.S. provisional patent application identified by Ser. No. 60/279,639, filed on Mar. 29, 2001, the disclosure of which is incorporated by reference herein.

### FIELD OF THE INVENTION

The present invention relates generally to the field of secure communication, and more particularly to techniques for attacking a screening algorithm.

### BACKGROUND OF THE INVENTION

Security is an increasingly important concern in the delivery of music or other types of content over global communication networks such as the Internet. More particularly, the successful implementation of such network-based content delivery systems depends in large part on ensuring that content providers receive appropriate copyright royalties and that the delivered content cannot be pirated or otherwise subjected to unlawful exploitation.

With regard to delivery of music content, a cooperative development effort known as Secure Digital Music Initiative (SDMI) has recently been formed by leading recording industry and technology companies. The goal of SDMI is the development of an open, interoperable architecture for digital music security. This will answer consumer demand for convenient accessibility to quality digital music, while also providing copyright protection so as to protect investment in content development and delivery. SDMI has produced a standard specification for portable music devices, the SDMI Portable Device Specification, Part 1, Version 1.0, 1999, and an amendment thereto issued later that year, each of which are incorporated by reference.

The illicit distribution of copyright material deprives the holder of the copyright legitimate royalties for this material, and could provide the supplier of this illicitly distributed material with gains that encourage continued illicit distributions. In light of the ease of information transfer provided by the Internet, content that is intended to be copy-protected, such as artistic renderings or other material having limited distribution rights, are susceptible to wide-scale illicit distribution. For example, the MP3 format for storing and transmitting compressed audio files has made the wide-scale distribution of audio recordings feasible, because a 30 or 40 megabyte digital audio recording of a song can be compressed into a 3 or 4 megabyte MP3 file. Using a typical 56 kbps dial-up connection to the Internet, this MP3 file can be downloaded to a user's computer in a few minutes. Thus, a malicious party could read songs from an original and legitimate CD, encode the songs into MP3 format, and place the MP3 encoded song on the Internet for wide-scale illicit distribution. Alternatively, the malicious party could provide a direct dial-in service for downloading the MP3 encoded song. The illicit copy of the MP3 encoded song can be subsequently rendered by software or hardware devices, or can be decompressed and stored onto a recordable CD for playback on a conventional CD player.

A number of schemes have been proposed for limiting the reproduction of copy-protected content. SDMI and others advocate the use of “digital watermarks” to identify authorized content. U.S. Pat. No. 5,933,798, “Detecting a watermark embedded in an information system,” issued Jul. 16, 1997 to Johan P. Linnartz, discloses a technique for watermarking electronic content, and is incorporated by reference herein. As in its paper watermark counterpart, a digital watermark is embedded in the content so as to be detectable, but unobtrusive. An audio playback of a digital music recording containing a watermark, for example, will be substantially indistinguishable from a playback of the same recording without the watermark. A watermark detection device, however, is able to distinguish these two recordings based on the presence or absence of the watermark. Because some content may not be copy-protected and hence may not contain a watermark, the absence of a watermark cannot be used to distinguish legitimate from illegitimate material.

Other copy protection schemes are also available. For example, European Patent No. EP983687A2, “Copy Protection Schemes for Copy-protected Digital Material,” issued Mar. 8, 2000 to Johan P. Linnartz and Johan C. Talstra, presents a technique for the protection of copyright material via the use of a watermark “ticket” that controls the number of times the protected material may be rendered, and is incorporated by reference herein.

An accurate reproduction of watermarked content will cause the watermark to be reproduced in the copy of the watermarked content. An inaccurate, or lossy, reproduction of watermarked content, however, may not provide a reproduction of the watermark in the copy of the content. A number of protection schemes, including those of the SDMI, have taken advantage of this characteristic of lossy reproduction to distinguish legitimate content from illegitimate content, based on the presence or absence of an appropriate watermark. In the SDMI scenario, two types of watermarks are defined: “robust” watermarks, and “fragile” watermarks. A robust watermark is one that is expected to survive a lossy reproduction designed to retain a substantial portion of the original content, such as an MP3 encoding of an audio recording. That is, if the reproduction retains sufficient information to allow a reasonable rendering of the original recording, the robust watermark will also be retained. A fragile watermark, on the other hand, is one that is expected to be corrupted by a lossy reproduction or other illicit tampering.

In the SDMI scheme, the presence of a robust watermark indicates that the content is copy-protected, and the absence or corruption of a corresponding fragile watermark when a robust watermark is present indicates that the copy-protected content has been tampered with in some manner. An SDMI compliant device is configured to refuse to render watermarked material with a corrupted watermark, or with a detected robust watermark but an absent fragile watermark, except if the corruption or absence of the watermark is justified by an “SDMI-certified” process, such as an SDMI compression of copy-protected-content for use on a portable player. For ease of reference and understanding, the term “render” is used herein to include any processing or transferring of the content, such as playing, recording, converting, validating, storing, loading, and the like. This scheme serves to limit the distribution of content via MP3 or other compression techniques, but does not affect the distribution of counterfeit unaltered (uncompressed) reproductions of content material. This limited protection is deemed commercially viable, because the cost and inconvenience of downloading an extremely large file to obtain a song will tend to discourage the theft of uncompressed content.

Despite SDMI and other ongoing efforts, existing techniques for secure distribution of music and other content suffer from a number of significant drawbacks. For example, SDMI has recently proposed the use of a new screening algorithm referred to as SDMI Lite. The SDMI Lite algorithm screens a limited number of segments of the content which is being downloaded, and only those segments having a duration which is greater than a predetermined threshold value. The screening algorithms are designed to detect watermarks in the content. Prior to adopting this screening approach industry wide, apparatus and methods must be identified which would successfully circumvent proposed screening algorithms.

### SUMMARY OF THE INVENTION

The present invention provides apparatus and methods for attacking and circumventing screening algorithms, as described herein. The invention involves transforming the illicit content so that the content looks as if it does not contain a watermark. If the screening algorithm does not detect a watermark in the content, the content will be admitted into the secure domain.

An advantage of the present invention is that it identifies at least one fault in a security screening algorithm. It is only through the detection and identification of faults that the underlying screening algorithm can be improved to provide convenient, efficient and cost-effective protection for all content providers.

In accordance with one aspect of the invention, a method of attacking a screening algorithm is provided. The method includes the steps of transforming content to manipulate a watermark within the content, subjecting the content to a screening algorithm, and transforming the content to reverse any manipulation performed on a watermark in the content during the first transforming step.

A watermark within the content is manipulated during the first transforming step by, for example, adding a pseudo-random sequence. The second transforming step removes the pseudo-random sequence or otherwise reverses the manipulation performed on the content during the first transforming step, after the content has been admitted into the secure domain.

These and other features and advantages of the present invention will become more apparent from the accompanying drawings and the following detailed description.

### BRIEF DESCRIPTION OF THE DRAWINGS

FIG. 1A is a schematic diagram of an illustrative embodiment of the present invention;

FIG. 1B is a schematic diagram of another illustrative embodiment of the present invention;

FIG. 2 is a block diagram illustrating a processing device for use in accordance with an embodiment of the present invention; and

FIG. 3 is a flow diagram of a method of attack on a screening algorithm in accordance with an illustrative embodiment of the present invention.

### DETAILED DESCRIPTION OF THE INVENTION

The present invention provides apparatus and methods which attack and circumvent screening algorithms that rely on a sampling of data for the purpose of detecting a watermark in the content, and, specifically, the proposed SDMI Lite and CDSafe screening algorithms as described herein. The CDSafe algorithm is described more fully in pending U.S. patent application Ser. No. 09/536,944, filed Mar. 28, 2000, in the name of inventors Toine Staring, Michael Epstein and Martin Rosner, entitled “Protecting Content from Illicit Reproduction by Proof of Existence of a Complete Data Set via Self-Referencing Sections,” which is incorporated by reference herein. The present invention is based on the concept of transforming the content to the extent that the content “looks” like non-watermarked material and thus it passes through the screen.

Advantageously, the invention detects faults in the proposed security screening algorithms. It is only through the detection and identification of faults that the underlying screening algorithm can be improved to provide convenient, efficient and cost-effective protection for all content providers.

One goal of SDMI is to prevent the unlawful and illicit distribution of content on the Internet. In an attempt to accomplish this goal, SDMI has proposed methods of screening content that has been identified to be downloaded. One such proposal is the previously-mentioned SDMI Lite screening algorithm. The new SDMI Lite screening algorithm was proposed in an attempt to improve the performance of SDMI.

Generally, the SDMI Lite screening algorithm randomly screens a predetermined number of sections of the marked content to determine whether the content is legitimate (e.g., whether the content contains a watermark). However, this and other similar screening algorithms are susceptible to an attack whereby content is transformed to the point that it is disguised as non-watermarked material.

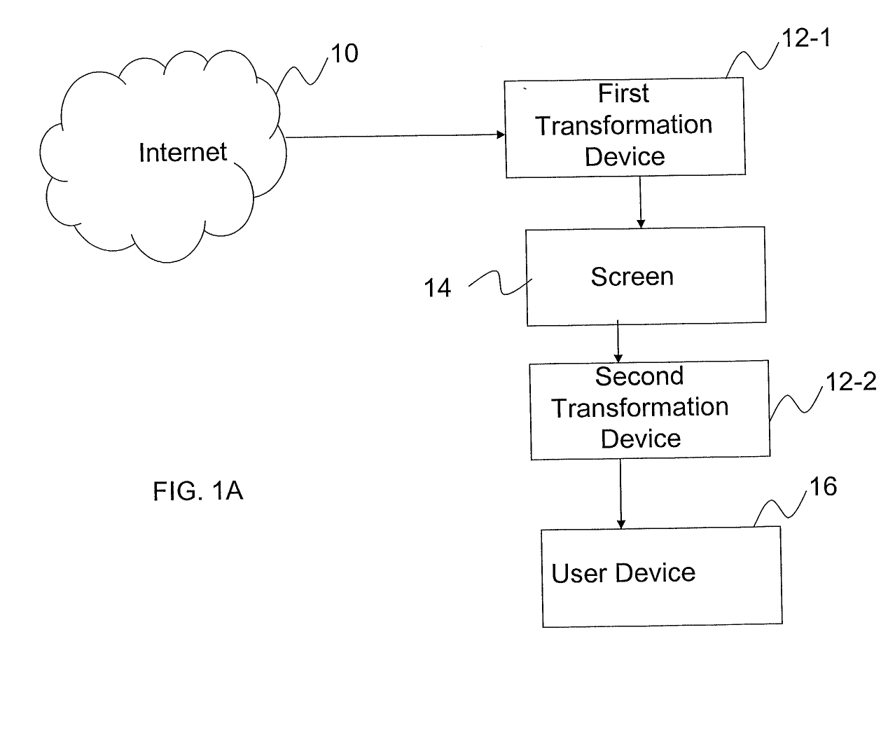

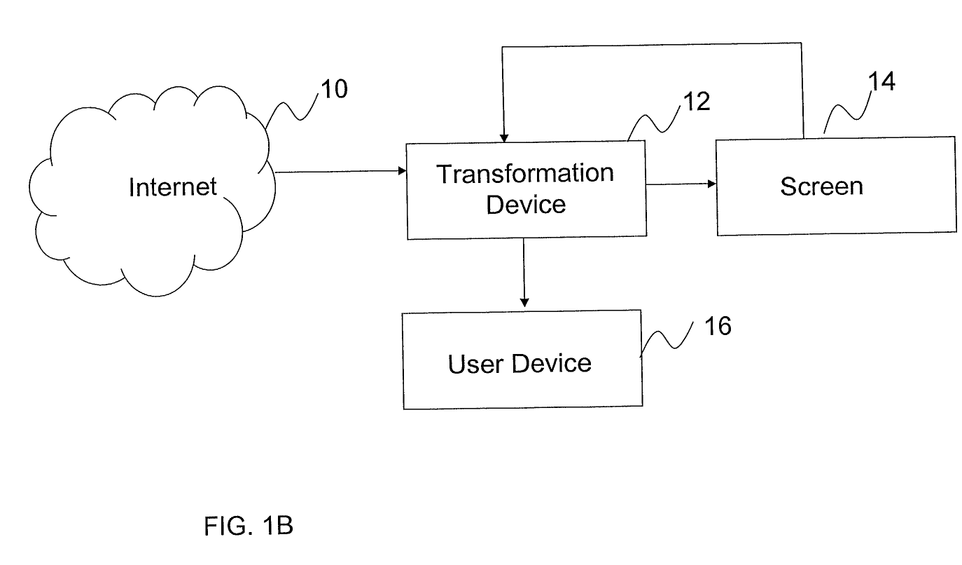

The present invention is achieved by initiating an attack on a screening algorithm by transforming the content so that the content appears to the screening algorithm to be non-watermarked content. More specifically, with reference to FIG. 1A, one method of attacking the proposed SDMI Lite screening algorithm and the CDSafe algorithm is to first identify content that is proposed to be downloaded from an external source such as, for example, the Internet 10. The content is then forwarded to a first transformation device 12-1 wherein the content is manipulated to the extent that a watermark embedded in the content will not be detected by a screening algorithm 14. The transformation device 12-1 is preferably a digital signal processor, but may be implemented using other processing devices. Therefore, digital content having a digital watermark may be digitally altered by methods known to those having ordinary skill in the art, such that the watermark cannot be detected by the screening algorithm 14. Preferably, the transformation device 12-1 will add a pseudo-random sequence to the content in order to remove substantially all traces of coherent watermarks. The particular pseudo-random sequence to use may depend on the content, e.g., the particular audio content. In general, the pseudo-random sequence should degrade the signal-to-noise ratio of the content to such a degree that the watermark detector is no longer able to detect a watermark. In addition, the properties of the pseudo-random sequence should be such that its effect on the content can be reversed after acceptance by the screening algorithm 14.

It is also contemplated that the content may be transformed through other means such as, for example, reversing all sections of the content, swapping the most and least significant bytes in one or more 16-bit samples, and any other means known to one having ordinary skill in the art.

Once the content is transformed, the transformed content is submitted to the screening algorithm 14. Because of the extent of the transformation that is performed on the content, there is a high likelihood that the screening algorithm will not detect a watermark and the content will be admitted into the secure domain.

To complete the attack, once the content has passed through the screening algorithm 14, the content is again passed through a second transformation device 12-2. The purpose of the second pass through a transformation device 12-2 is to reverse the manipulations of the content performed by the first transformation device 12-1. For example, where a pseudo-random sequence was added to the content, the second transformation device 12-2 will remove the pseudo-random sequence from the content, to restore the integrity of the illicit content. Once the content is admitted into the secure domain, the user may access the content. User device 16 may be a personal computer, a compact disc player or any other device designed to access the content.

The content may be passed through the same or another transformation device. FIG. 1B is illustrative of an embodiment of the present invention wherein a single transformation device 12 is utilized. Similar to the embodiment discussed above with reference to FIG. 1A, another method of attacking the proposed SDMI Lite screening algorithm and the CDSafe algorithm is to first identify content that is proposed to be downloaded from an external source such as, for example, the Internet 10. The content is then forwarded to a transformation device 12 wherein the content is manipulated to the extent that a watermark embedded in the content will not be detected by a screening algorithm 14.

Once the content is transformed, the transformed content is submitted to the screening algorithm 14. Because of the extent of the transformation that is performed on the content, there is a high likelihood that the screening algorithm will not detect a watermark and the content will be admitted into the secure domain.

To complete the attack, once the content has passed through the screening algorithm 14, the content is again passed through a transformation device. In this embodiment of the present invention, the content is passed through the same transformation device used in the first pass, i.e., transformation device 12. The purpose of the second pass through transformation device 12 is to reverse the manipulations of the content performed during the first pass. For example, where a pseudo-random sequence was added to the content, during the second pass, transformation device 12 will remove the pseudo-random sequence from the content, to restore the integrity of the illicit content. Once the content is admitted into the secure domain, the user may access the content via user device 16. User device 16 may be a personal computer, a compact disc player or any other device designed to access the content.

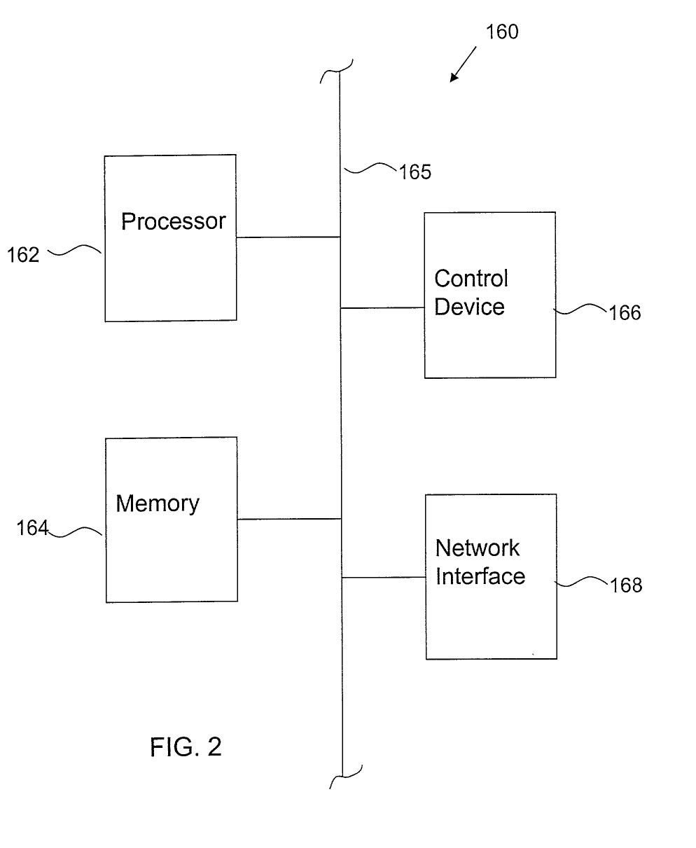

FIG. 2 shows an example of a processing device 160 that may be used to implement, e.g., a program in accordance with the present invention. The device 160 includes a processor 162 and a memory 164 which communicate over at least a portion of a set 165 of one or more system buses. Also utilizing at least a portion of the set 165 of system buses are a control device 166 and a network interface device 168. The device 160 may represent, e.g., one or more of the transformation device 12, user device 16 or any other type of processing device for use in implementing at least a portion of the above-described transformation processes in accordance with the present invention. The elements of the device 160 may correspond to conventional elements of such devices.

For example, the processor 162 may represent a microprocessor, central processing unit (CPU), digital signal processor (DSP), or application-specific integrated circuit (ASIC), as well as portions or combinations of these and other processing devices. The memory 164 is typically an electronic memory, but may comprise or include other types of storage devices, such as disk-based optical or magnetic memory.

As indicated previously, the transformation techniques described herein may be implemented in whole or in part using software stored and executed using the respective memory and processor elements of the device 160. For example, the transformation process may be implemented at least in part using one or more software programs stored in memory 164 and executed by processor 162. The particular manner in which such software programs may be stored and executed in device elements such as memory 164 and processor 162 is well understood in the art and therefore not described in detail herein.

It should be noted that the device 160 may include other elements not shown, or other types and arrangements of elements capable of providing the transformation functions described herein. A given one of the processing elements of FIGS. 1A and 1B, e.g., the transformation device, may be implemented using only a subset of the elements of FIG. 2, e.g., the processor 162 and memory 164.

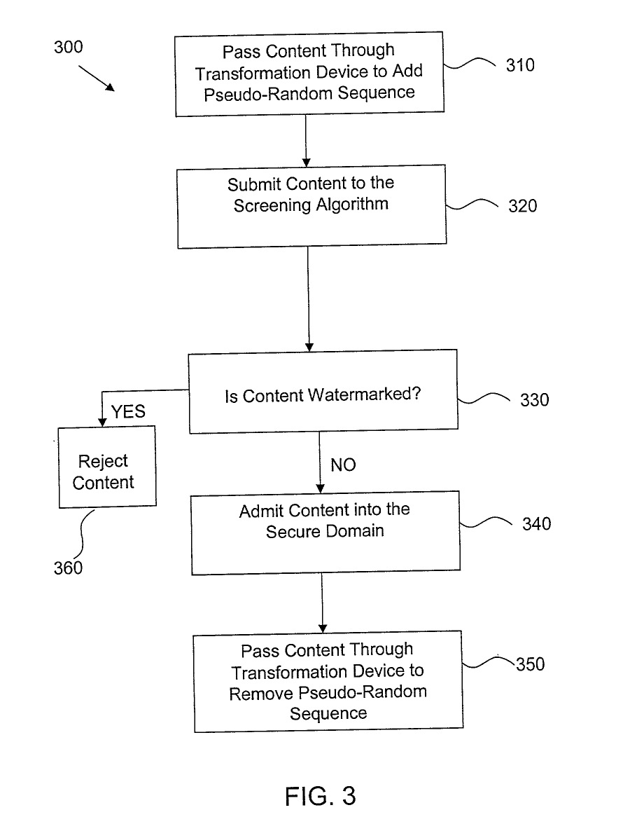

Referring now to FIG. 3, a flow diagram 300 is shown illustrating a method of attacking a screening algorithm in accordance with an embodiment of the present invention.

The first step 310 in an embodiment of the method of attacking a screening algorithm in accordance with the present invention is to pass the illicit content through a transformation device. The transformation device adds a pseudo-random sequence to the content to remove any traces of coherent watermarks in the content.

In the next step 320, the content will be subjected to a screening algorithm such as, for example, the above-noted CDSafe or SDMI Lite screening algorithm. The purpose of the screening algorithm is to ensure that illicit content does not get admitted into a secure domain, such as the SDMI domain. To determine whether the content should be admitted into the secure domain, the screening algorithm screens the content for the existence of a watermark. As indicated by step 330, if a watermark is detected, the content is rejected in block 360. If a watermark is not detected, the content will be admitted into the secure domain as indicated in step 340.

Once inside the secure domain, according to step 350, the attacker will pass the content through a transformation device again, to remove the pseudo-random sequence from the content. As indicated above, the same transformation device may be used for steps 310 and 350, or different transformation devices may be used for each of these steps. Once this procedure is complete, the content may be played or otherwise accessed. At this point, the attacker has successfully downloaded illicit content thereby circumventing the screening algorithm.

The above-described embodiments of the invention are intended to be illustrative only. Although the present invention is described with reference to the SDMI screening algorithm, the present invention may be applied to any screening algorithm. These and numerous other embodiments within the scope of the following claims will be apparent to those skilled in the art.

What is claimed is:

1. A method of attacking a screening algorithm, the method comprising the steps of:
transforming content to manipulate a watermark within the content;
subjecting the content to a screening algorithm; and
transforming the content to reverse any manipulation performed on a watermark in the content during the first transforming step.

2. The method of attacking a screening algorithm as recited in claim 1 further comprising the step of adding a pseudo-random sequence to the content during the first transforming step.

3. The method of attacking a screening algorithm as recited in claim 2 further comprising the step of removing the pseudo-random sequence added to the content during the first transforming step.

4. The method of attacking a screening algorithm as recited in claim 1 further comprising the step of removing a watermark from the content.

5. The method of attacking a screening algorithm as recited in claim 1 wherein the screening algorithm comprises a Secure Digital Music Initiative screening algorithm.

6. The method of attacking a screening algorithm as recited in claim 1 wherein the screening algorithm screens the content for a watermark.

7. The method of attacking a screening algorithm as recited in claim 1 further comprising the step of admitting the content to a secure domain after subjecting the content to the screening algorithm, when no watermark is detected.

8. The method of attacking a screening algorithm as recited in claim 1 further comprising the step of manipulating the watermark by reversing all sections of the content.

9. The method of attacking a screening algorithm as recited in claim 1 wherein the first and second transforming steps are performed in the same transformation device.

10. An apparatus for attacking a screening algorithm comprising:
a processing device having a processor coupled to a memory, the processing device being operative to transform content to be downloaded to manipulate a watermark embedded in the content, wherein the content is subjected to a screening algorithm, the memory storing the content when the content passes through the screening algorithm.

11. The apparatus for attacking a screening algorithm as recited in claim 10 wherein the processing device removes the watermark embedded in the content.

12. The apparatus for attacking a screening algorithm as recited in claim 10 wherein the processing device comprises a digital signal processor.

13. An article of manufacture for attacking a screening algorithm, the article comprising a machine readable medium containing one or more programs which when executed implement the steps of:
transforming content to manipulate a watermark within the content;
subjecting the content to a screening algorithm; and
transforming the content to reverse any manipulation performed on a watermark in the content during the first transforming step.

14. The article of manufacture for attacking a screening algorithm as recited in claim 13 further comprising the step of adding a pseudo-random sequence to the content during the first transforming step.

15. The article of manufacture for attacking a screening algorithm as recited in claim 13 wherein the first and second transforming steps are performed in respective first and second transformation devices.

16. The article of manufacture for attacking a screening algorithm as recited in claim 13 further comprising the step of removing a watermark from the content.

17. The article of manufacture for attacking a screening algorithm as recited in claim 13 wherein the screening algorithm screens the content for a watermark.

18. The article of manufacture for attacking a screening algorithm as recited in claim 13 further comprising the step of admitting the content to a secure domain after subjecting the content to the screening algorithm, when no watermark is detected.

19. The article of manufacture for attacking a screening algorithm as recited in claim 13 further comprising the step of writing downloaded content to a user device.

20. The article of manufacture for attacking a screening algorithm as recited in claim 13 further comprising the step of swapping the most and least significant bytes in a 16-bit sample.
